(19) United States
(12) Patent Application Publication
(10) Pub. No.: US 2020/0298314 A1
(43) Pub. Date: Sep. 24, 2020

(54) MACHINE TOOL AND DRAG FRAME CONVEYOR FOR FEEDING/REMOVING WORKPIECES

(71) Applicant: EMCO Magdeburg GmbH, Magdeburg (DE)

(72) Inventor: Christian Wilhelm, Bernburg (DE)

(21) Appl. No.: 16/822,648

(22) Filed: Mar. 18, 2020

(30) Foreign Application Priority Data
Mar. 20, 2019 (DE) 10 2019 203 790.9

(51) Int. Cl. B23B 13/02

(52) U.S. Cl. CPC B23B 13/021

(57) ABSTRACT

A machine tool comprises a machine frame, a first spindle having a first workholder rotatable about a first axis, a second spindle having a second workholder rotatable about a second axis, a first tool carrier for machining one side of a workpiece in the first spindle, and a second tool carrier for machining a different side of a workpiece in the second spindle. The second spindle is arranged on a spindle carrier movable relative to the machine frame, using a carriage system, in parallel with and transversely to the first axis. The second workpiece spindle is pivotal on the spindle carrier, using a pivoting device, about a pivot axis that extends perpendicularly to a movement plane. The second tool carrier is positioned on a guide carriage movable relative to the machine frame in parallel with the pivot axis. A drag frame conveyor is provided to feed or transport workpieces.

### CROSS-REFERENCE TO RELATED APPLICATIONS

This application claims priority to German application no. 10 2019 203 790.9, filed Mar. 20, 2019, which is herein incorporated by reference in its entirety.

### TECHNICAL FIELD

The present disclosure relates to a machine tool, in particular a lathe, for machining workpieces, in particular for machining bar stock. The present disclosure also relates to a drag frame conveyor for feeding workpieces to be machined to a machine tool, or for removing workpieces machined by the machine tool.

### BACKGROUND

Lathes for machining workpieces in which both ends of the workpiece can be machined in one machine tool, i.e. in which double-end machining of the workpiece can be carried out, are known.

In the lathe of this kind described in DE 195 21 846 A1, one workpiece spindle is mounted in each of two spindle heads in a rotationally drivable manner. On the side opposite the workpiece spindle, each spindle head bears a tool holder. The tools received therein are used to machine the workpiece clamped on the workpiece spindle of the other spindle head in each case. This lathe makes it possible to transport the workpieces entirely automatically without providing any additional workpiece handling devices, and also enables double-end machining of the workpieces. For this purpose, with the first workpiece spindle oriented vertically, the workpiece is received by a horizontal contact surface by means of workpiece clamping means of said workpiece spindle, and once said first workpiece spindle has been pivoted to the horizontal the workpiece is machined by the tools positioned in the tool holder of the second spindle head, and then transferred to the chuck of the second workpiece spindle. In the second workpiece spindle, the then second side of the workpiece is machined by the tools provided on the first spindle head, and once the second workpiece spindle has been pivoted into the vertical position, is set down on a workpiece bearing surface.

Since each spindle head bears both a workpiece spindle and tools, and both spindle heads are involved in the machining process during each machining, only one workpiece at a time can ever be machined during the machining period, and no other workpiece can be handled during this time either. The time from the pick-up of a starting workpiece to the setting down of a completely machined workpiece is therefore relatively long, and the throughput of such lathes is rather low.

For the above reasons, there has therefore long been an aim to provide lathes in which machining processes and handling processes can overlap in time.

In this regard, DE 199 04 859 A1, for example, teaches a lathe comprising two workpiece spindles that are mounted on a machine bed so as to be movable in a direction of a first, horizontal axis and in the direction of a second, vertical axis and are provided with workpiece clamping means, each of which is pivotable about a third axis which is perpendicular to the plane spanned by the first and second axes. Here, the workpiece spindles are formed such that their axes of rotation are in alignment while a workpiece is being transferred from the one workpiece spindle to the other. In addition, horizontal contact surfaces for workpieces are provided below the workpiece clamping means which are pivotable vertically downwards together with the workpiece spindles, the workpiece spindles being configured in a suspended arrangement when the axis of rotation is vertical in order to machine the workpieces held in the workpiece clamping means, and a tool holder being arranged on the machine bed below the suspended workpiece clamping means.

Furthermore, DE 10 2004 004 019 B4 describes a lathe comprising a first workpiece spindle which is arranged on a machine frame and has a first workholder that is rotatable about a first spindle axis, and a second workpiece spindle which is arranged on the machine frame and has a second workholder that is rotatable about a second spindle axis. In the lathe described, the second workpiece spindle is pivotable about a pivot axis extending transversely to the second spindle axis, and specifically from a position in which the second spindle axis extends in parallel or coaxially with the first spindle axis into a position in which the second spindle axis is oriented transversely to the first spindle axis.

What is also described is a first tool carrier equipped with at least one tool for machining one side of a workpiece held in the first workpiece spindle, a second tool carrier equipped with at least one tool for machining a different side of a workpiece held in the second workpiece spindle. In order to directly transfer the workpiece machined on the one side from one of the workholders to the other workholder, the first and second workpiece spindles, having mutually facing workholders, can be moved into a transfer position of the workpiece spindles. Here, the spindle axes are oriented coaxially with one another and can be moved in the direction of the axes, a bar feed device being assigned to the first workpiece spindle for loading the unworked workpiece. The fully machined workpiece can be transferred to a workpiece removal device from the second workpiece spindle which has a second spindle axis extending transversely to the first spindle axis.

However, the above-described lathe has the problem that when the workpiece is delivered to the downstream workpiece removal device by the second workpiece spindle, the workpiece can only be positioned on the workpiece removal device, in particular on a carrier element of the workpiece removal device, in an imprecise manner, the position and orientation information on the workpiece available in the lathe thereby being lost when the workpiece is transferred to the workpiece removal device.

### SUMMARY

The problem addressed by this disclosure is that of providing a machine tool that is capable of overlapping machining processes and handling processes in time so as to minimize the time from a starting workpiece being picked up to a completely machined workpiece being set down, while also making the position and orientation information on the machined workpiece obtained in the machine tool available for downstream machining steps and simultaneously realizing a compact and inherently rigid design to prevent unnecessary oscillatory motion that could jeopardize the machining result.

This problem is solved by a machine tool, in particular a lathe, according to either claim 1 or claim 12. In addition, the disclosure provides a drag frame conveyor having an elevating platform for feeding workpieces to a machine tool or removing workpieces therefrom, said conveyor being configured to transmit the position and orientation information obtained by the machine tool to downstream machining steps.

In this respect, one of the core concepts of the present disclosure is to provide a machine tool that has two workpiece spindles, of which the workpiece spindle arranged further downstream in the machining flow of the machine tool can be brought at least into a vertical orientation, i.e. the workpiece spindle has at least one position in which one spindle axis thereof is perpendicular to a floor surface on which a machine frame of the machine tool stands, and said workpiece spindle can be moved in this vertical direction by means of a carriage system.

Since the workpiece spindle that carries out the final machining of the workpiece within the machine tool can assume a position in which the workpiece spindle is oriented vertically, and can also be shifted in the vertical direction, it is possible to transfer the fully machined workpiece to a downstream transport device, for example, without losing the position and orientation information on the workpiece obtained in the machine tool.

It is also conceivable to receive, by means of said workpiece spindle, an already machined workpiece, fed to the machine tool together with position and orientation information, without losing this position and orientation information.

According to one embodiment, a machine tool, in particular a lathe, for machining workpieces, in particular for machining bar stock, comprises: a machine frame, a first workpiece spindle which is arranged on the machine frame and has a first workholder which is rotatable about a first spindle axis, a second workpiece spindle which is arranged on the machine frame and has a second workholder which is rotatable about a second spindle axis, a first tool carrier equipped with at least one tool for machining one side of a workpiece held in the first workpiece spindle, and a second tool carrier equipped with at least one tool for machining a different side of a workpiece held in the second workpiece spindle, wherein the second workpiece spindle is arranged on a spindle carrier which can be moved relative to the machine frame, by means of a first carriage system, in parallel with the first spindle axis in a so-called X-direction and transversely, in particular perpendicularly, to the first spindle axis in a so-called Z₂-direction, the second workpiece spindle can be pivoted on the spindle carrier, by means of a pivoting device, about a pivot axis that extends perpendicularly to a movement plane defined by the X-direction and the Z₂-direction, and the second tool carrier is positioned on a guide carriage which can be moved relative to the machine frame in parallel with the pivot axis extending in a so-called Y-direction.

According to an alternative embodiment, a machine tool, in particular a lathe, for machining workpieces, in particular for machining bar stock, comprises: a machine frame, a first workpiece spindle which is arranged on the machine frame and has a first workholder which is rotatable about a first spindle axis, a second workpiece spindle which is arranged on the machine frame and has a second workholder which is rotatable about a second spindle axis, a first tool carrier equipped with at least one tool for machining one side of a workpiece held in the first workpiece spindle, and a second tool carrier equipped with at least one tool for machining a different side of a workpiece held in the second workpiece spindle, wherein the second workpiece spindle is arranged on a spindle carrier which can be moved relative to the machine frame, by means of a first carriage system, in parallel with the first spindle axis in a so-called X-direction and transversely, in particular perpendicularly, to the first spindle axis in a so-called Z₂-direction, the second tool carrier is positioned on a second carriage system which can be moved relative to the machine frame at least in the X-direction, and the second tool carrier can be pivoted on the second carriage system, by means of a pivoting device, about a pivot axis that extends perpendicularly to a movement plane defined by the X-direction and the Z₂-direction.

Furthermore, it may be advantageous if the second tool carrier can also be moved relative to the machine frame, by means of the second carriage system, in the Z₂-direction and/or in parallel with the pivot axis extending in a so-called Y-direction.

In addition, the second tool carrier may have a third workholder, by means of which the workpiece being machined in the first workpiece spindle is received and can be transferred to the second workpiece spindle for further machining.

Furthermore, the third workholder may be realized by a chuck integrated in a turret plate of a turret of the second tool carrier.

Furthermore, the first tool carrier may be positioned on a third carriage system which is movable relative to the machine frame in parallel with the first spindle axis in the X-direction and transversely, in particular perpendicularly, to the first spindle axis in a so-called Z₁-direction.

In addition, it may be advantageous for the movement direction Z₁-direction of the third carriage system of the first tool carrier to form an angle of approximately 30° to 60°, preferably 45°, with a floor surface on which the machine frame stands.

According to a further embodiment, the third carriage system and the first carriage system may use common guide rails in the X-direction.

Furthermore, a bar feed device, in particular a bar loader, may be arranged on the first workpiece spindle for loading the unmachined workpiece.

In addition, it may be advantageous if the first workpiece spindle is formed as a direct drive having a hollow shaft, in which the unmachined workpiece can be fed to the first workholder through the hollow shaft of the direct drive.

Furthermore, the first workpiece spindle and/or the second workpiece spindle may be formed as a direct drive, preferably a synchronous motor, having a maximum torque in the range of 200 to 400 Nm and a speed in the range of 0 to 5000 rpm.

According to a further embodiment, the first workpiece spindle may be formed as a stationary workpiece spindle.

In addition, the guide carriage may be provided within the machine frame, in particular below the guide rails.

Furthermore, it may be advantageous if the second workpiece spindle or the second tool carrier can be pivoted into a coaxial position in which the first workholder is coaxial with the second workholder or the first workholder is coaxial with the third workholder.

Furthermore, the pivoting device may be formed as a clewing ring.

Furthermore, it may be advantageous if the machine tool comprises a transport device, in particular a workpiece removal device, by means of which workpieces machined by the machine tool can be transported away and/or fed to a further machining apparatus. However, it is also possible to feed workpieces, in particular already machined workpieces, to the machine tool by means of the transport device.

According to a further embodiment, when the second workpiece spindle is in a vertical orientation in which it is perpendicular to the first spindle axis and perpendicular to the floor surface, said spindle assumes an unloading position, in which it is possible to transfer the workpiece machined on the rear side, or the fully machined workpiece, to the transport device.

In addition, the transport device may be formed as a drag frame conveyor, an indexing pallet conveyor or a shuttle.

Furthermore, it may be advantageous for the transport device to be formed as a drag frame conveyor having an elevating platform, the elevating platform being configured to be mounted so as to be movable in a setting-down/pick-up direction of the second workpiece spindle, which is perpendicular to the floor surface.

The present disclosure further relates to a drag frame conveyor for feeding workpieces to a machine tool or removing workpieces therefrom, in particular a machine tool according to any of the preceding claims, comprising: a chain drive having a circulating chain for transporting a plurality of drag frames which circulate in a continuous manner on a top side of the drag frame conveyor, and an elevating platform configured to be mounted so as to be movable in a setting-down/pick-up direction of the workpieces to be transported, which is perpendicular to a floor surface on which the drag frame conveyor stands.

In addition, it may be advantageous if the elevating platform has a movable member and a base plate rigidly connected to the drag frame conveyor, the movable member being pushed against adjustable stop screws, preferably four countersunk head screws acting as a stop for the movable member, by means of at least two compression springs, preferably four compression springs, fastened to the base plate, as a result of which the movable member can be positioned and secured in an upper position.

According to an embodiment, a bottom plate of the movable member has four holes, in particular counterbores, through which the adjustable stop screws pass, as a result of which the movable member is guided transversely to its movement direction which corresponds to the setting-down/pick-up direction of the workpieces.

Furthermore, the elevating platform may be configured such that a workpiece bearing surface of the elevating platform, which is a top side of the movable member, can be oriented approximately level with the top side of the drag frame conveyor, the orientation being able to be carried out by means of the adjustable stop screws.

In addition, it may be advantageous if the elevating platform has a pressing monitor, by means of which a pressing path extending in the direction of the movement direction of the movable member can be monitored, the monitoring preferably being done by means of two Hall effect sensors.

### BRIEF DESCRIPTION OF THE DRAWINGS

FIG. 1 is a schematic perspective view of a lathe according to the prior art, FIG. 2 is a schematic perspective view of an additional lathe according to the prior art, FIG. 3 is a schematic perspective view of a lathe according to a first embodiment of the present disclosure,

FIG. 4 is a schematic perspective view of a lathe according to a second embodiment of the present disclosure,

FIG. 5 is a schematic perspective view of the lathe according to the first embodiment, in the state in which the first workpiece spindle is loaded with an unworked workpiece by means of a bar loader,

FIG. 6 is a schematic perspective view of the lathe according to the first embodiment, in the state in which the workpiece machined by the first workpiece spindle is transferred to the second workpiece spindle,

FIG. 7 is a schematic perspective view of the lathe according to the first embodiment, in the state in which the second workpiece spindle is pivoted back into the vertical orientation and the workpiece is machined by a tool of the second tool holder,

FIG. 8 is a schematic perspective view of the lathe according to the first embodiment, in the state in which the fully machined workpiece is transferred to a downstream transport device by means of the second workpiece spindle, FIG. 9 is a perspective detailed view of the downstream transport device which is formed as a drag frame conveyor having an elevating platform,

FIG. 10 is a perspective detailed view of the elevating platform of the drag frame conveyor.

### DETAILED DESCRIPTION

In the following, embodiments of the present disclosure will be described in detail on the basis of the accompanying figures. Further modifications stated in this context with regard to particular features can each be individually combined to form additional embodiments.

Equal or corresponding elements are each provided with the same or similar reference numerals in the various figures.

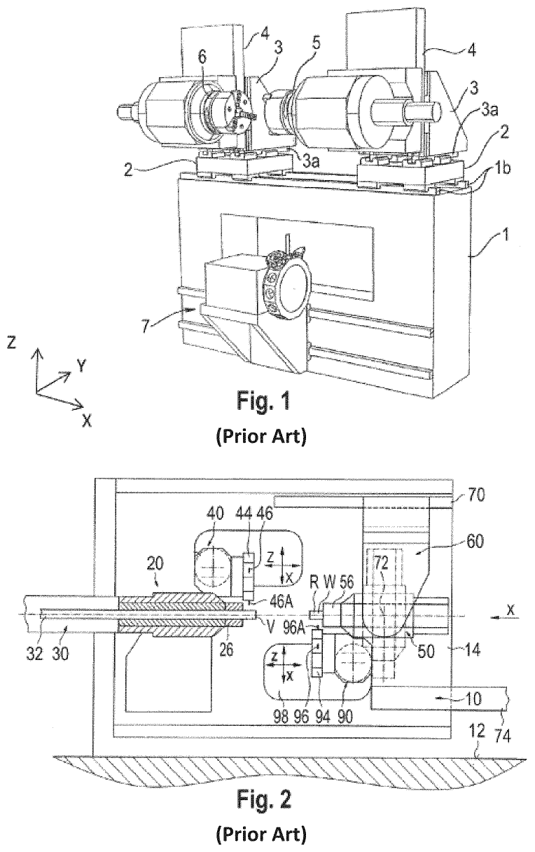

FIG. 1 is a schematic perspective view of a lathe according to the prior art. The lathe shown in FIG. 1 has a machine bed 1 and two workpiece spindles 5 and 6. Two parallel strips, on which a tool holder 7 can be oriented, are provided on the vertical front of the machine bed 1. The machine bed 1 is formed as a structure that bears bed guides 1b on top. Two bed carriages 2 are provided on the bed guides 1b so as to be horizontally displaceable by means of guide shoes. The bed carriages 2 bear cross slides 3, on which saddles 4 are guided in turn. Pivot mountings 5d and 6d are pivotally fastened to the saddles 4, each of which bears a workpiece spindle 5 and 6 formed as integrated motor spindles.

The cross slides 3 are configured as brackets, on the underside of which plane guides 3a are provided. The plane guides 3a slide in guide shoes on the top of the bed carriage 2. Longitudinal guides 3b, in which the saddle 3 can move in the vertical direction, are provided on the front of the cross slides 3. The advancing drives for the carriages 2, 3 and 4 are not shown. In this way, the workpiece spindles 5 and 6 are each movable in the three spatial directions X, Y and Z, and pivotable about a pivot axis parallel to the Y-axis.

FIG. 2 is a schematic perspective view of an additional lathe according to the prior art. The lathe shown comprises a machine frame denoted as a whole by 10, which rises above a floor surface 12 and has a machine bed 14 on which a first workpiece spindle 20 is held, which has a first workholder 26. The first workpiece spindle 20 is assigned a bar feed device 30, by means of which a material bar 32 can be fed to the first workholder 26 through a hollow shaft of a spindle motor 24 of the workpiece spindle 20. In order to machine the received material bar 32, a first tool carrier 40 is assigned to the first workpiece spindle 20, which comprises a rotatable turret head 44, in which a plurality of first tools 46 are arranged.

The relative movement between the first tool 46A and the workpiece WR can be achieved, for example, by the first tool carrier 40 being positioned on a carriage system which is movable relative to the machine bed 14 in parallel with the first spindle axis 28 in a Z-direction and perpendicularly to the first spindle axis in an X-direction.

In addition, a second workpiece spindle 50 is arranged on the machine bed 14, which also has a second workholder 56. Here, the second workholder 56 is used for receiving the workpiece W being machined on its front V in the first workpiece spindle 20 with the front V and for machining the rear side R thereof.

To take the workpiece W being machined on the front V over from the first workpiece spindle 20, the second workpiece spindle 50 can be oriented coaxially with the first workpiece spindle 20 and moved in the direction of the first workpiece spindle 20.

For this purpose, the second workpiece spindle 50 is held in a second spindle carrier denoted as a whole by 60, which is displaceable in parallel with the Z-direction by means of longitudinal guides 68, 70. The second workpiece spindle 50 can also be pivoted in the second spindle carrier 60 about a pivot axis 72 that extends perpendicularly to a movement plane E spanned by the two directions X and Z. As a result, the second workpiece spindle 50 can be pivoted from a position coaxial with the first workpiece spindle 20 into a position shown in dash-dot lines in FIG. 2, in which the second workholder 56 is facing the floor surface 12.

The position of the second workpiece spindle 50, which is shown in dash-dot lines in FIG. 2, corresponds to an unloading position, in which it is possible to transfer the workpiece W that has been machined on the rear side R over to a workpiece removal device 74.

To machine the workpiece W on the rear side R in the second workpiece spindle 50, a second tool carrier 90 is provided, which has a turret head 94 on which second tools 96 are arranged. The second tool carrier 90 is also arranged on a second carriage system 98 which is movable in the Z-direction and the X-direction.

FIG. 3 is a schematic perspective view of a lathe 1 according to a first embodiment of the present disclosure. The lathe 1 shown has a machine frame 10, a first workpiece spindle 20 arranged on the machine frame 10 on the left in the viewing direction of FIG. 3, and a second workpiece spindle 30 arranged on the right in the viewing direction of FIG. 3. Both workpiece spindles 20, 30 are provided with workholders 22, 32 which are rotatable about spindle axes 21, 31 of the workpiece spindles 20, 30. In order to receive the workpiece W, the workholders 22, 32 are preferably configured as chuck. In addition, the lathe 1 shown has a first tool carrier 40, formed as a turret, for receiving a plurality of tools and providing them for machining the workpiece W received in the first workpiece spindle.

As can also be seen in FIG. 3, the top of the machine frame 10 is sloped on the front, the slope preferably having an angle of 45°. This makes it possible to attach the first workpiece spindle 20, which is formed as a stationary workpiece spindle 20 having a horizontally oriented spindle axis 21, to the machine frame 10 at an angle of 45°, whereby the chips accumulating during lathing can be easily removed since they slide down on the slope of the machine frame 10 and can be collected, for example, in a collection container not shown.

Furthermore, the first workpiece spindle 20 has a direct drive formed as a hollow-shaft drive. In this way, it is possible to supply unworked bar stock to the first workholder 22 from the side, in FIG. 3 from the right, through the hollow shaft of the direct drive by means of a bar loader 200.

In addition, the first tool carrier 40 is positioned on a third carriage system 110 which is also arranged at an upward angle of 45°, i.e. in parallel with the slope of the machine frame 10. Thereby, the width or depth of the machine tool 1 can be reduced since the carriage system 110 makes use of the clear space in the vertical direction. The third carriage system 110 consists of two guide carriages, the first guide carriage enabling movement in parallel with the first spindle axis 21 in a so-called X-direction and the second guide carriage enabling movement perpendicular to the first spindle axis in a so-called Z₁-direction. In the embodiment shown, and as described above, the Z₁-direction forms a 45° angle with a floor surface G on which the machine frame 10 is installed. The two guide rails 71 of the first guide carriage are assembled on the top of the machine frame.

In addition, the lathe 1 shown has a second tool carrier 50 which is likewise formed as a turret and receives a plurality of tools which are held in readiness for machining a workpiece W held in the second workpiece spindle 30. As can be seen in FIG. 3, the second tool carrier 50 is arranged on the right-hand side of the machine frame 10 and below the spindle carrier 60.

The second workpiece spindle 30 is arranged on a spindle carrier 60 which can be displaced relative to the machine frame 10, by means of a first carriage system 70, in parallel with the first spindle axis 21 in the X-direction. In addition, the first carriage system 70 enables movement of the second workpiece spindle 30 perpendicularly to the first spindle axis 21 in a so-called Z₂-direction which extends in the vertical direction, i.e. perpendicularly to the floor surface G, in the position shown.

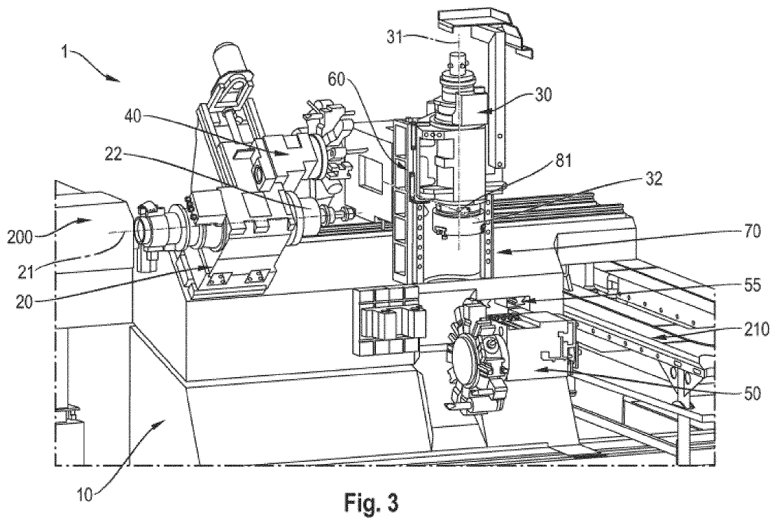

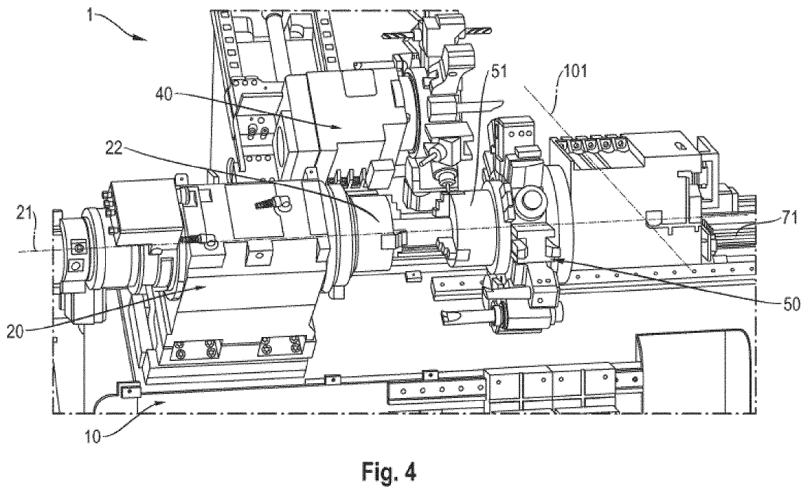

The first carriage system 70 in turn consists of two guide carriages, the first guide carriage using the same guide rails 71 as the first guide carriage of the third carriage system 110. The first guide carriage bears a bracket 61 of the spindle carrier 60, on which a second bracket 62 can be pivoted, by means of a pivoting device 80, in particular a clewing ring not shown, about a pivot axis 81 that extends perpendicularly to a movement plane E spanned by the X-direction and the Z₂-direction. On the second bracket 62, a second carriage is arranged, on which the second workpiece spindle 30 is positioned and thus is movable in two directions and pivotable about an axis, specifically the pivot axis 81. Depending on the pivot position of the second bracket 62, the second workpiece spindle 30 can, for example, be oriented and moved perpendicularly to the first spindle axis 21 (as shown in FIG. 3) or in parallel with the first spindle axis 21 (as shown in FIG. 4).

As can likewise be seen in FIG. 3, the second tool carrier 50 has a guide carriage 55 which is movable relative to the machine frame 10 in parallel with the pivot axis 81 extending in a so-called Y-direction, i.e. in the depth direction in FIG. 3.

It can also be seen in FIG. 3 that it is advantageous for the lathe 1 to be provided with a transport device, in particular a workpiece removal device, that allows the workpieces W machined by the lathe 1 to be transported away automatically.

It can further be seen in FIG. 3 that the slope of the machine frame 10 on the front has an additional advantage, namely that, as a result, the second bracket 62 can be brought closer to the second tool carrier 50, whereby the rigidity of the spindle carrier 60 is increased and thus the machining accuracy of the second workpiece spindle 30 is improved.

In the embodiment shown, the guide carriage 55 of the second tool carrier is also arranged in the machine frame, in particular below the spindle carrier 60 or the guide rails 71, as a result of which the lathe 1 can also be designed to be more compact.

FIG. 4 is a schematic perspective view of a lathe 1 according to a second or alternative embodiment of the present disclosure. The second embodiment has substantially the same construction as the first embodiment of the present disclosure described above in relation to FIG. 1. The main difference is only that the second workpiece spindle 30 is not formed to be pivotable. To be able to keep the required installation space of the lathe 1 as small as possible, the second workpiece spindle is oriented vertically.

However, to still be able to transfer workpieces from the first workpiece spindle 20 to the second workpiece spindle 30 automatically, the lathe according to the second embodiment has a second tool carrier that is positioned on a second carriage system 90 which can be moved relative to the machine frame 10 at least in the X-direction, i.e. in parallel with the first spindle axis 21. In addition, the second tool carrier 50 can be pivoted on the second carriage system 90, by means of a pivoting device 100, about a pivot axis 101 that extends perpendicularly to a movement plane E defined by the X-direction and the Z₂-direction.

As can likewise be seen in FIG. 4, the second tool carrier 50 can also be moved in the Z₂-direction by means of the second carriage system 90, thereby making it possible to move the second tool carrier 50 in the direction of the second workpiece spindle 30 in order to machine a clamped workpiece.

To transfer the workpiece from the first workpiece spindle 20 to the second workpiece spindle 30, the second tool carrier 50 has a third workholder 51 which in this embodiment is implemented as a chuck integrated in a turret plate of a turret of the second tool carrier 50.

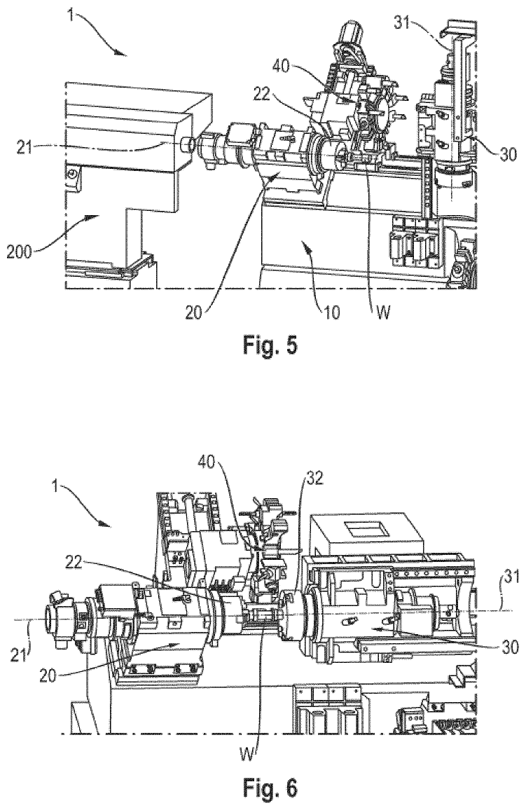

FIG. 5 shows the lathe 1 according to the first embodiment, in the state in which the first workpiece spindle 20 is loaded with an unworked workpiece by means of a bar loader 200.

FIG. 6 also shows the lathe 1 according to the first embodiment, but in the state in which the workpiece W machined by the first workpiece spindle 20 is transferred to the second workpiece spindle 30. As is typical for lathes, the workpiece W clamped in the first workpiece spindle 20 can only be machined on the exposed side V. For that reason, it is necessary to withdraw the workpiece W from the workpiece spindle 20 and re-insert it into the workpiece spindle 20 with the other side R exposed, or, as shown, to transfer it to the second workholder 32 of the second workpiece spindle 30 which, for this purpose, is pivoted into a horizontal position in which the two spindle axes 21, 31 of the two workpiece spindles 20, 30 are oriented coaxially with one another. Here, the workpiece W is transferred from the first workholder 22 to the second workholder 32 in such a way that the rear side R of the workpiece W, which has so far not been machined and has been used in the first workholder 22 to clamp the workpiece W, is now exposed.

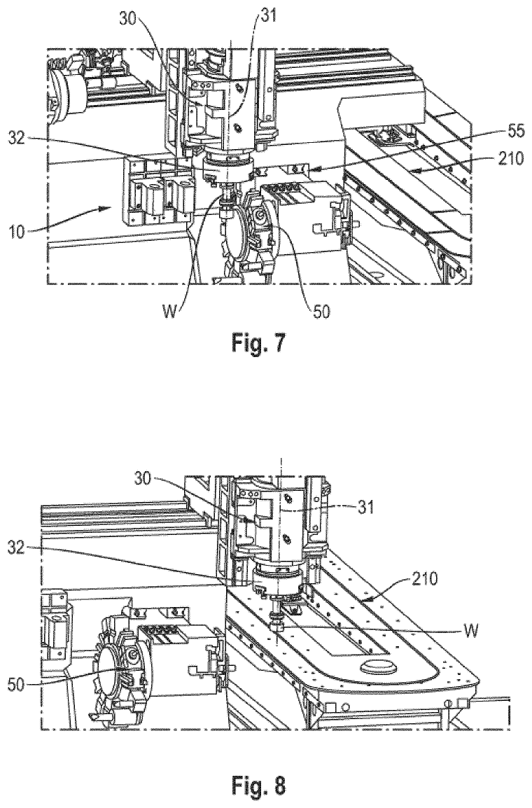

FIG. 7 shows the lathe 1 according to the first embodiment, in the state in which the second workpiece spindle 30 is pivoted back into the vertical orientation and the workpiece W is machined by a tool of the second tool holder 50. For this purpose, and as shown, the second workpiece spindle 30 which is positioned on the spindle carrier 60 is brought into a lowermost position on the second carriage of the first carriage system 70 in order to bring the received workpiece W into a machining zone of the second tool holder 50.

Once the rear side R of the workpiece W has been machined in the second workpiece spindle 30, as shown in FIG. 8 the workpiece W is transferred to a downstream transport device 210 by means of the second workpiece spindle 30 which is in a vertically oriented position. For this purpose, by means of the spindle carrier 60, in particular the second carriage of the first carriage system 70, the second workpiece spindle 30 is brought into an upper position, in which the workpiece W can be brought by means of the transport device 210 and optionally set down on a workpiece carrier not shown, which is provided on the transport device 210 for transporting the workpiece W. To simplify the transfer from the second workpiece spindle 30 to the transport device 210, in particular onto the workpiece carrier, the transport device 210, which is formed as a drag frame conveyor according to the first embodiment of the present disclosure, has an elevating platform 220 which is mounted so as to be movable in the setting-down direction of the second workpiece spindle 30, which is vertical in FIG. 9. This makes it possible to compensate for tolerances between the workpiece carrier and the delivery position of the second workpiece spindle 30 in the vertical direction.

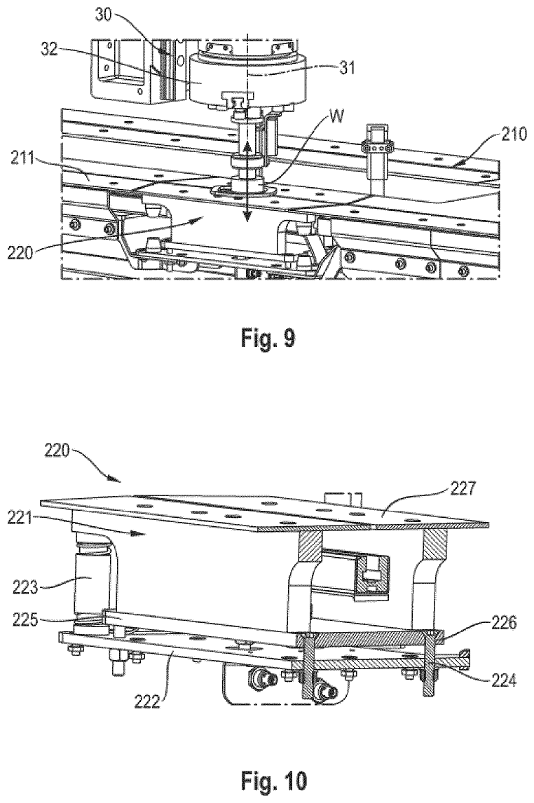

FIG. 10 is a perspective detailed view of the elevating platform 220 of the drag frame conveyor 210. The drag frame conveyor 210 has a chain drive not shown, which has a circulating chain and by means of which a plurality of drag frames (not shown) are transported continuously, i.e. in closed circulation, on a top side 211 of the drag frame conveyor 210.

The elevating platform 220 has a movable member 221 and a base plate 222 rigidly connected to the drag frame conveyor 210, the movable member 221 being pushed against adjustable stop screws 224, formed as four countersunk head screws, by means of four compression springs 223 fastened to the base plate 222, as a result of which the movable member 221 can be positioned and secured in an upper position.

When the elevating platform 220 is in the upper position, a workpiece bearing surface 227 of the elevating platform 220, which is a top side of the movable member 221, is oriented approximately level with the top side 211 of the drag frame conveyor 210, the orientation being carried out by means of the adjustable stop screws 224.

If the fully machined workpiece W is now set down on the workpiece bearing surface 227 of the elevating platform 220 means of the second workpiece spindle 30, and the underside of the workpiece W, corresponding to the front V of the workpiece, is intentionally or unintentionally pushed against the workpiece bearing surface 227 (referred to as overshooting the setting-down position), the workpiece bearing surface 227 can yield downwards due to the spring-loaded mounting of the movable member 221. The second workpiece spindle 30 pushes the movable member 221 downwards, as a result of which the four countersunk heads of the countersunk head screws 224 release from four counterbores 226 provided on the top side of a bottom plate 225 of the movable member 221, and the bottom plate 225 slides downwards in a manner guided along the four countersunk head screws 224, in particular in the transverse direction.

If the second workpiece spindle 30 opens its second workholder 32, the movable member 221 of the elevating platform 220 is pushed back into the upper position by the four compression springs 223, as a result of which the bottom plate 225 moves upwards again along the countersunk head screws 224 and the countersunk heads of the countersunk head screws 224 are positioned back into the countersinks of the counterbores 226, thereby centering the bottom plate 225 and thus the movable member 221.

As can also be seen in FIG. 10, the elevating platform 220 shown has a pressing monitor, by means of which a pressing path extending in the direction of the movement direction B of the movable member 221 can be monitored, the monitoring being done by means of two Hall effect sensors.

From the above description, the person skilled in the art will recognize that various modifications and variations of the apparatus of the disclosure can be made without departing from the scope of the disclosure. Moreover, apparatus has been described in relation to particular embodiments, which however are intended solely for better understanding the apparatus, not for limiting the apparatus. The person skilled in the art will also immediately recognize that many different combinations of elements can be used to carry out the present disclosure.

Even if the above-described embodiments state a particular number of components, a different number of these components can be used according to further embodiments.

1. A machine tool, in particular a lathe, for machining workpieces, in particular bar stock, comprising:
a machine frame,
a first workpiece spindle arranged on the machine frame and having a first workholder which is rotatable about a first spindle axis,
a second workpiece spindle arranged on the machine frame and having a second workholder which is rotatable about a second spindle axis,
a first tool carrier equipped with at least one tool configured to machine one side of a workpiece held in the first workpiece spindle, and
a second tool carrier equipped with at least one tool configured to machine a different side of a workpiece held in the second workpiece spindle, wherein
the second workpiece spindle is arranged on a spindle carrier which is movable relative to the machine frame, by a first carriage system, in parallel with the first spindle axis in a so-called X-direction and transversely, in particular perpendicularly, to the first spindle axis in a so-called Z2-direction,
the second workpiece spindle being pivotal on the spindle carrier, by a pivoting device, about a pivot axis that extends perpendicularly to a movement plane defined by the X-direction and the Z2-direction, and
the second tool carrier is positioned on a guide carriage which is movable relative to the machine frame in parallel with the pivot axis extending in a so-called Y-direction.

2. The machine tool according to claim 1, wherein the first tool carrier is positioned on a third carriage system which is movable relative to the machine frame in parallel with the first spindle axis in the X-direction and transversely, in particular perpendicularly, to the first spindle axis in a so-called Z1 direction.

3. The machine tool according to claim 1, wherein a bar feed device, in particular a bar loader, is arranged on the first workpiece spindle for loading the unmachined workpiece.

4. The machine tool according to claim 1, wherein the first workpiece spindle is formed as a direct drive having a hollow shaft, wherein the unmachined workpiece is to be fed to the first workholder through the hollow shaft of the direct drive.

5. The machine tool according to claim 1, wherein the first workpiece spindle and/or the second workpiece spindle is/are formed as a direct drive, preferably a synchronous motor, having a maximum torque in the range of 200 to 400 Nm and a speed in the range of 0 to 5000 rpm.

6. The machine tool according to claim 1, wherein the first workpiece spindle is formed as a stationary workpiece spindle.

7. The machine tool according to claim 1, wherein the guide carriage is provided within the machine frame, in particular below the guide rails.

8. The machine tool according to claim 1, wherein the second workpiece spindle or the second tool carrier is pivotal into a coaxial position wherein the first workholder is coaxial with the second workholder or the first workholder is coaxial with the third workholder.

9. The machine tool according to claim 1, wherein the pivoting device is formed as a clewing ring.

10. The machine tool according to claim 1, further comprising a transport device, in particular a workpiece removal device, configured to transport workpieces machined by the machine tool away and/or fed to a further machining apparatus.

11. A drag frame conveyor for feeding workpieces to a machine tool or removing workpieces therefrom, wherein the machine tool is according to claim 1, the drag frame conveyor comprising:
a chain drive having a circulating chain configured to transport a plurality of drag frames which circulate in a continuous manner on a top side of the drag frame conveyor, and
an elevating platform configured to be mounted so as to be movable in a setting down/pick-up direction of the workpieces to be transported, which is perpendicular to a floor surface on which the drag frame conveyor stands.

12. A machine tool, in particular a lathe, for machining workpieces, in particular bar stock, comprising:
a machine frame,
a first workpiece spindle arranged on the machine frame and having a first workholder which is rotatable about a first spindle axis,
a second workpiece spindle arranged on the machine frame and having a second workholder which is rotatable about a second spindle axis,
a first tool carrier equipped with at least one tool configured to machine one side of a workpiece held in the first workpiece spindle, and
a second tool carrier equipped with at least one tool configured to machine a different side of a workpiece held in the second workpiece spindle, wherein
the second workpiece spindle is arranged on a spindle carrier which is movable relative to the machine frame, by a first carriage system, in parallel with the first spindle axis in a so-called X-direction and transversely, in particular perpendicularly, to the first spindle axis in a so-called Z2-direction,
the second tool carrier is positioned on a second carriage system which is movable relative to the machine frame at least in the X-direction, and
the second tool carrier being pivotal on the second carriage system, by a pivoting device, about a pivot axis that extends perpendicularly to a movement plane defined by the X-direction and the Z2-direction.

13. The machine tool according to claim 12, wherein the second tool carrier is movable relative to the machine frame, by the second carriage system, in the Z2-direction and/or in parallel with the pivot axis extending in a so-called Y direction.

14. The machine tool according to claim 12, wherein the second tool carrier has a third workholder.

15. The machine tool according to claim 14, wherein the third workholder is realized by a chuck integrated in a turret plate of a turret of the second tool carrier.

16. The machine tool according to claim 12, wherein the first tool carrier is positioned on a third carriage system which is movable relative to the machine frame in parallel with the first spindle axis in the X-direction and transversely, in particular perpendicularly, to the first spindle axis in a so-called Z1 direction.

17. The machine tool according to claim 16, wherein the movement direction Z1-direction of the third carriage system of the first tool carrier forms an angle of approximately 30° to 60°, preferably 45°, with a floor surface on which the machine frame stands.

18. The machine tool according to claim 16, wherein the third carriage system and the first carriage system use common guide rails in the X direction.

19. The machine tool according to claim 12, wherein a bar feed device, in particular a bar loader, is arranged on the first workpiece spindle for loading the unmachined workpiece.

20. The machine tool according to claim 12, wherein the first workpiece spindle is formed as a direct drive having a hollow shaft, wherein the unmachined workpiece is to be fed to the first workholder through the hollow shaft of the direct drive.

21. The machine tool according to claim 12, wherein the first workpiece spindle and/or the second workpiece spindle is/are formed as a direct drive, preferably a synchronous motor, having a maximum torque in the range of 200 to 400 Nm and a speed in the range of 0 to 5000 rpm.

22. The machine tool according to claim 12, wherein the first workpiece spindle is formed as a stationary workpiece spindle.

23. The machine tool according to claim 12, wherein the guide carriage is provided within the machine frame, in particular below the guide rails.

24. The machine tool according to claim 12, wherein the second workpiece spindle or the second tool carrier is pivotal into a coaxial position wherein the first workholder is coaxial with the second workholder or the first workholder is coaxial with the third workholder.

25. The machine tool according to claim 12, wherein the pivoting device is formed as a clewing ring.

26. The machine tool according to claim 12, further comprising a transport device, in particular a workpiece removal device, configured to transport workpieces machined by the machine tool away and/or fed to a further machining apparatus.

27. The machine tool according to claim 26, wherein, when the second workpiece spindle is in a vertical orientation in which it is perpendicular to the first spindle axis and to the floor surface, the spindle assumes an unloading position, wherein the workpiece machined on the rear side to the transport device is transferable.

28. The machine tool according to claim 26, wherein the transport device is formed as a drag frame conveyor, an indexing pallet conveyor or a shuttle.

29. The machine tool according to claim 26, wherein the transport device is formed as a drag frame conveyor having an elevating platform, wherein the elevating platform is configured to be mounted so as to be movable in a setting down/pick-up direction of the second workpiece spindle, which is perpendicular to the floor surface.

30. A drag frame conveyor for feeding workpieces to a machine tool or removing workpieces therefrom, wherein the machine tool is according to claim 12, the drag frame conveyor comprising:
a chain drive having a circulating chain configured to transport a plurality of drag frames which circulate in a continuous manner on a top side of the drag frame conveyor, and
an elevating platform configured to be mounted so as to be movable in a setting down/pick-up direction of the workpieces to be transported, which is perpendicular to a floor surface on which the drag frame conveyor stands.

31. The drag frame conveyor according to claim 30, wherein the elevating platform comprises:
a movable member; and
a base plate rigidly connected to the drag frame conveyor,
wherein the movable member is pushed against adjustable stop screws, preferably four countersunk head screws acting as a stop for the movable member, by at least two compression springs, preferably four compression springs, fastened to the base plate, wherein the movable member is to be positioned and secured in an upper position.

32. The drag frame conveyor according to claim 31, wherein a bottom plate of the movable member has four holes, in particular counterbores, through which the adjustable stop screws pass, as a result of which the movable member is guided transversely to its movement direction which corresponds to the setting-down/pick-up direction of the workpieces.

33. The drag frame conveyor according to claim 30, wherein the elevating platform is configured to orient a workpiece bearing surface of the elevating platform, which is a top side of the movable member, approximately level with the top side of the drag frame conveyor, wherein the orientation can be carried out by the adjustable stop screws.

34. The drag frame conveyor according to claim 30, wherein the elevating platform has a pressing monitor configured to monitor a pressing path extending in the direction of the movement direction of the movable member, the monitoring preferably being performed by two Hall effect sensors.
